(19) United States
(12) Patent Application Publication
(10) Pub. No.: US 2005/0135974 A1
(43) Pub. Date: Jun. 23, 2005

(54) Device for preparing multiple assay samples using multiple array surfaces

(76) Inventors: Michael A. Harvey, Spofford, NH (US); Lara K. Dowland, Jaffery, NH (US); Breck O. Parker, Keene, NH (US); Stephen B. Sherman, Keene, NH (US); To Cheung, Siu Sai Wan (HK); Bin Li, Shanghai (CN); Yong Ji Peng, Shanghai (CN); Qi- Feng Cai, Shanghai (CN); Ke Qin Liu, Shanghai (CN); Hai Peng Ge, Shanghai (CN); Fu Qiao Deng, Shanghai (CN); Li Ding, Shanghai (CN)

Correspondence Address: BRIAN D. VOYCE, 8401 STERLING BRIDGE ROAD, CHAPEL HILL, NC, 27516, US

(21) Appl. No.: 10/739,784

(22) Filed: Dec. 18, 2003

(51) Int. Cl. G01N 31/22

(52) U.S. Cl. 422/102; 422/165; 422/57

(57) ABSTRACT

The present invention relates to a device for preparing assay samples using a number of microscope slides. Each slide has a number of assay reaction surface locations spaced on the planar surface of the slide. In preferred embodiments, the device comprises, in part, a microscope slide holder that has the exterior dimensions of a SBS standard microplate, such as a 96 well plate. The device accepts conventional microscope slides equipped with sixteen microarray surfaces spaced nine millimeters apart on center, or four for a 96 well plate. Individual chamber plates are placed on top of the slides, creating an individual well above each assay reaction surface location. In preferred embodiments, each assay reaction surface location can comprise a microarray of multiple reactive sites. Thus, parallel processing can be done of samples for genomic or proteomic profiling. An advantage of the present invention is that one can use the conventional high throughput assaying equipment for SBS standard microplates while using conventional microscope slides, thereby allowing the use of robotic assay reading equipment designed for slides.

### BACKGROUND OF THE INVENTION

(1) Field of the Invention

The present invention relates to a device for preparing assay samples using a number of microscope slides. Each slide has a number of assay reaction surface locations spaced on the planar surface of the slide. In preferred embodiments, the device comprises, in part, a microscope slide holder that has the exterior dimensions of a SBS standard microplate, such as a 96 well plate. The device accepts conventional microscope slides equipped with sixteen microarray surfaces spaced nine millimeters apart on center, or four for a 96 well plate. Individual chamber plates are placed on top of the slides, creating an individual well above each assay reaction surface location. In preferred embodiments, each assay reaction surface location can comprise a microarray of multiple reactive sites. Thus, parallel processing can be done of samples for genomic or proteomic profiling. An advantage of the present invention is that one can use the conventional high throughput assaying equipment for SBS standard microplates while using conventional microscope slides, thereby allowing the use of robotic assay reading equipment designed for slides.

(2) Description of the Related Art, Including Information Disclosed Under 37 CFR 1.97 & 1.98

Multiwell test plates (otherwise referred to in the art as either microtiterplates or microplates) are essential tools for scientists looking to assay many samples at a time. In an effort to provide more flexibility to microplates, the art has incorporated various features. As seen in U.S. Pat. No. 5,679,310, the microplate has been modified to include high surface area structure on the bottom interior of the wells. It has also been modified to use a porous separation medium at the bottom interior of the well so as to facilitate separation of liquids from solids in samples (see U.S. Pat. No. 5,417,923). Gasketed tops have been added to microplates to prevent cross contamination of samples (see U.S. Pat. No. 5,516,490).

With the development of genomics and proteomics, technologies are required that permit the automated processing of large numbers of samples that are interrogated with a large number of binding elements. Microchip technologies have provided numerous solutions that allow investigators to determine multiple reactivities within a given biological sample.

DNA and protein microarrays have become important methods to allow the simultaneous interrogation of multiple binding reactions (cf. Schena, M. et al., Science 270:467-469(1995), Duggan, D. J., et al., Nature Genetics 21:10-14,(1999), MacBeath, G. and Schrieber, S. L. Science 289:1760-1763(2000). Testing multiple samples at the same time for binding activity against all the elements of a given array significantly increases the power of parallel processing with minimal sample volumes.

For example Schena et. Al describe immobilizing large numbers of oligonucleotides, representing genomic sequences, to a glass microscope slide and hybridizing probes made from the total RNA of a cell to these sequences. This provides, in one binding experiment, a view of all the genes expressed in that cell at that point in time. Similar microarrays have been described using large numbers of antibodies immobilized on glass slides to understand which proteins, and in what quantity, are expressed in a cell or group of cells at a particular point in time. The generation of these microarrays is dependent, in part, on spotting robots able to deliver small volumes of samples to precise locations on the glass slide.

### BRIEF SUMMARY OF THE INVENTION

Methods and devices to provide and improve high throughput analysis of biomolecules (nucleic acids, proteins etc.) are important for elucidation of protein function, diagnostic testing, drug discovery and drug target identification. One set of technologies that have improved the simultaneous interrogation of large numbers of biomolecules is the use of microarrays. Microarrays are ordered displays of molecules generally immobilized on a surface. Such an array permits the simultaneous investigation of binding of many elements to target molecules. A variety of technologies have been developed to allow investigators to make, process and detect reactions on microarrays.

An object of the invention is to provide addressable protein microarrays on a surface that binds many different proteins, maintains the protein three dimensional structure, and immobilizes them in sufficient quantity to allow for sensitive detection.

A second object of the invention is to be able to interrogate sensitively the same array of proteins with different samples or binding partners. Because specific protein binding partners are generally rare, any technique which allows the use of minimum quantities is preferred.

A third object of the invention is to use a convenient set of methodologies to allow high throughput techniques. In particular, an object of the invention is to use the “micro plate” 96 well format, which is based on 9 mm spacings of reaction areas which are 7 mm either in diameter or square. Many pipetting aids, detection instrumentation, liquid handling systems and robotics have been designed to conform to this format.

A fourth object of the present invention is to provide for parallel processing of substantially identical microarrays on multiple samples.

A fifth object of the present invention is to provide a device that can take a microscope slide based reaction surface and convert it for use with conventional microplate-based, high throughput robotic equipment.

In essence, what microarrays allow is the accumulation of large amounts of data due to parallel processing. To this point in time this has largely been accomplished by subjecting single biological samples to large numbers of binding elements. If multiple samples could be processed against multiple arrays the amount of information would increase. This is particularly important in drug discovery, diagnostic and prognostic applications of microarrays where simultaneous screening of multiple samples is essential for quality comparative results.

The present invention is a device for preparing multiple assay samples for multiple reactive sites located on at least one assay slide. Each slide comprises a planar support having a set of exterior edges and a planar surface covered with a plurality of separate and discretely spaced assay reaction surface locations. Each assay reaction surface location is treated so as to provide a reaction surface for a sample that is to be assayed for a genomic or proteomic activity. Conventional reagents well known to those of skill in the art can be used for such reactions, including proteins and nucleic acids, typically derived from sequences occurring in cells and tissues. Each assay location must have at least one assay reaction site, but typically can have a plurality of assay reaction sites per assay surface location, possibly hundreds of assay reaction sites. The assay location surfaces are present at a density of at least eight per eighteen square centimeters.

Along with the slides, the present invention comprises at least one planar multiwell chamber plates. Each chamber plate has a plurality of bottomless wells located between a top planar surface and a bottom planar surface and encompassed by a set of exterior wall surfaces. Each chamber plate is dimensioned and configured so as to register the wells with the assay reaction surface locations of a corresponding assay slide. Each chamber plate is located adjacent to and in registration with the corresponding assay slide. Each chamber plate well is dimensioned so as to encompass the area of a corresponding assay reaction surface location on the corresponding assay slide. Each well is discrete from the other and is dimensioned so as to receive a sample. Each well has an opening that can communicate with the corresponding assay reaction surface location.

A slide holder equipped with a plurality of slide openings holds the slides. Each slide opening is dimensioned and configured so as to receive an assay slide. In some embodiments the opening is in a horizontal surface of the slide holder and is designed to receive slides from a vertical movement (see FIGS. 1 and 2). In other embodiments, the opening is in a vertical surface of the slide holder and is designed to receive slides from a horizontal movement (see FIGS. 7 and 8). being attached to the slide holder. The slide retention means allows each microarray slide and corresponding chamber plate to be received in the corresponding opening in the slide holder, and yet when the slide is located in a proper registration position, to retain the slide within the opening. Thus, the slides can be secured for further reaction processing of the individual assay reaction surface locations using the wells of the chamber plate for reaction vessels.

The present invention also can comprise the use of a top for a securing means. As seen in FIGS. 3 and 4, the slide retention means comprises a top that can be attached to the upper surface of the slide holder such that each microarray slide and corresponding chamber plate received in the corresponding opening in the slide holder is retained within the opening.

The present invention also can combine a top and the chamber plates into a unitary structure, as seen in FIGS. 5 and 6.

The instant devices can be used in methods for processing multiple assay samples. Typically, one would add a sample to at least one prepared well in at least one chamber plate and corresponding slide in any of the above devices. The assay reaction surface location can be prepared either with the slide in the slide holder or before the slide is placed in the slide holder. Typically, one would apply a plurality of samples to each slide, each to a respective assay reaction surface location. In cases where parallel processing is desired, one would have a substantially identical set of assay reaction sites on each slide.

Using conventional parameters, one reacts the sample with the assay reaction surface location in the well.

Finally, one measures the signal from the reacted sample using conventional signal measurement techniques appropriate for the selected signal chemistries. In some cases, after reacting the sample with the prepared surface, one will need to perform at least one additional reaction to produce the measurable signal. The signal can be measured with the slide either in the slide holder or removed from the slide holder. The signal can be measured by a conventional robotic signal measurement means. If parallel processing is desired for the slides, then one compares the signal from the samples so as to identify redundant reaction patterns that indicate any similarities within the samples Suitable samples include proteomic or genomic samples such as is selected from the group consisting of cell lysates, cell supernatants, plasma, serum, or biological fluids.

### BRIEF DESCRIPTION OF THE DRAWINGS

FIG. 1 is an exploded perspective view of a first preferred embodiment of the present invention using a slide opening in a horizontal slide holder surface and a horizontal slide retention means in the slide holder.

FIG. 2 is a lateral sectional view of the first preferred embodiment in FIG. 1.

FIG. 3 is an exploded perspective view of a second preferred embodiment of the present invention using a slide opening in a horizontal slide holder surface and a slide holder top based slide retention means.

FIG. 4 is a lateral sectional view of the second preferred embodiment in FIG. 3.

FIG. 5 is an exploded perspective view of a third preferred embodiment of the present invention using a slide opening in a horizontal slide holder surface and a slide holder top based slide retention means incorporating chamber plates.

FIG. 6 is a lateral sectional view of the third preferred embodiment in FIG. 5.

FIG. 7 is an exploded perspective view of a fourth preferred embodiment of the present invention using a slide opening in a vertical slide holder surface and a vertical slide retention means in the slide holder.

FIG. 8 is a lateral sectional view of the fourth preferred embodiment in FIG. 7.

FIG. 9 is an end sectional view of the slide holder of the fourth preferred embodiment in FIG. 7.

FIG. 10 is an exploded perspective view of a fifth preferred embodiment of the pr esent invention using T-rails and end stops.

FIG. 11 is a top view of the slide holder of the fifth preferred embodiment in FIG. 10.

FIG. 12 is a digital image of arrays using the present invention.

FIG. 13 is a graph quantifying the results of the images in FIG. 12.

### DETAILED DESCRIPTION OF THE INVENTION

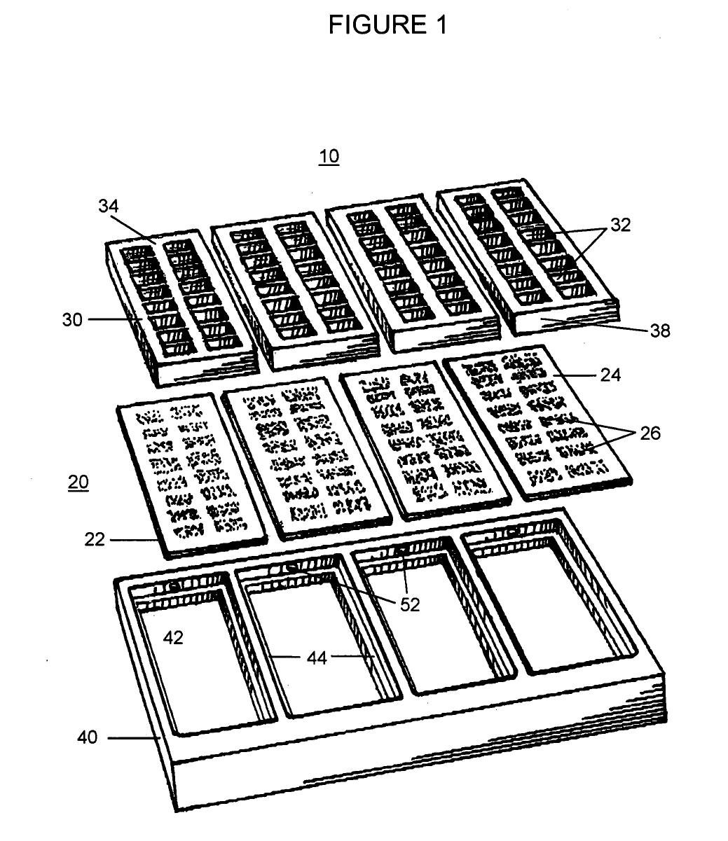

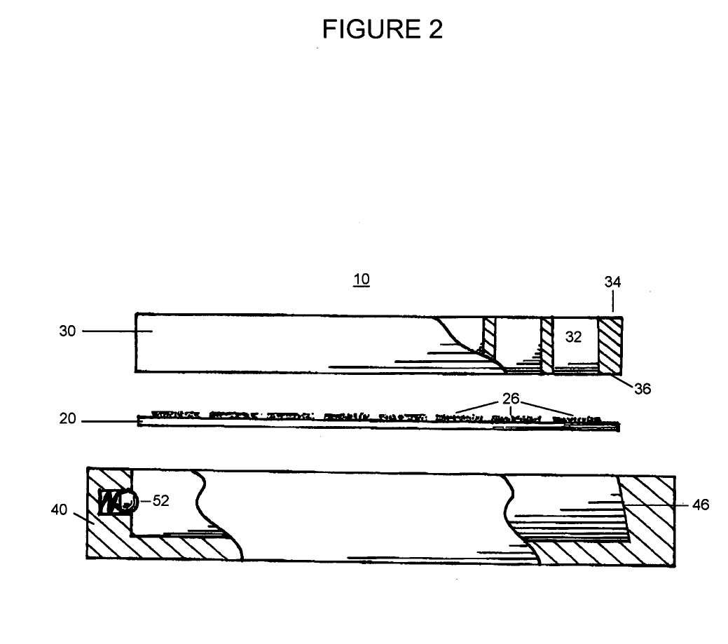

In preferred embodiments, the present invention relates to a device for preparing multiple assay samples (10). A first preferred embodiment is shown in FIGS. 1 and 2. The device is sized to the dimensions of an SBS standard multiwell microplate, in this illustration a 96 well microplate having a 9 mm spacing format. The device comprises four assay slides (20) held by a slide holder (40). Each slide is a standard-sized glass microscope slide (75 mm by 125 mm), comprising a planar support having a set of exterior edges (22) and a planar surface (24) covered with sixteen separate and discretely spaced assay locations (26). The assay locations are treated so as to provide a reaction surface for a sample that is to be assayed for a genomic or proteomic activity. The assay reaction surface locations are present at a density and spacing that is registerable with that of the 96 well microplate. Other conventional microplate formats include 24 wells, 64 wells, and 384 wells.

As seen in the Figures, the present invention also comprises four planar multiwell chamber plates (30) that are dimensioned to have the same planar area as the corresponding slides. Each chamber plate comprises sixteen bottomless wells (32) located between a top planar surface (34) and a bottom planar surface (36) and encompassed by a set of exterior wall surfaces (38). Each chamber plate is dimensioned and configured so as to allow the wells to be registerable with the assay location surfaces (26) of the microarray assay slide (20). Each chamber plate is located adjacent to and in registration with a corresponding assay slide. Each well is dimensioned to encompass the area of a corresponding assay reaction surface location on the corresponding assay slide, each well is discrete from the other and is dimensioned so as to receive a sample, and each well has an opening that can communicate with the corresponding assay location surface.

The chamber plate can be made of a material that is inert to any reaction that is to take place within the well and has an elastomeric nature, such as silicone rubber. The chamber plate can be releaseably secured to the corresponding slide by a releaseable sealing means located on the bottom planar surface of the chamber plate such that each slide can be releaseably engaged with the chamber plate, such as conventional releasable adhesives.

The present invention also comprises a slide holder (40) having four slide openings (42). Each slide opening is dimensioned and configured so as to receive an assay slide. Shoulders about the opening (44) support each slide in a registerable position. In addition, each slide opening can have one wall that slopes inward from an exterior wall of the slide holder such that the upper portion of the opening has an area less than that of the slide, thereby requiring the slide to be tilted in order to be received within the opening.

Suitable materials for the slide holder element of the present invention are conventional and known to those of skill in the art. Examples include acetal, polypropylene, PTFE, aluminum, stainless steel, polystyrene, or acrylics.

Finally, the present invention can have a slide retention means (50) attached to the slide holder. The slide retention means can be a spring-loaded depressable ball means (52) or a moveable protusion means. The slide retention means functions so as to allow each slide and corresponding chamber plate to be received in the corresponding opening in the slide holder, and yet be retained within the opening once seated in the opening.

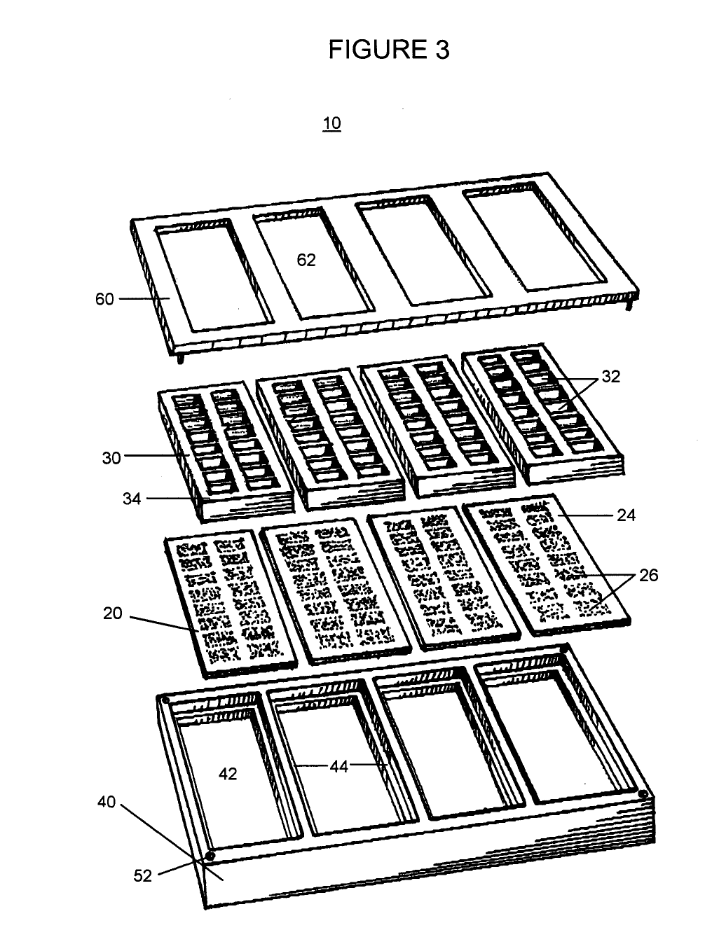

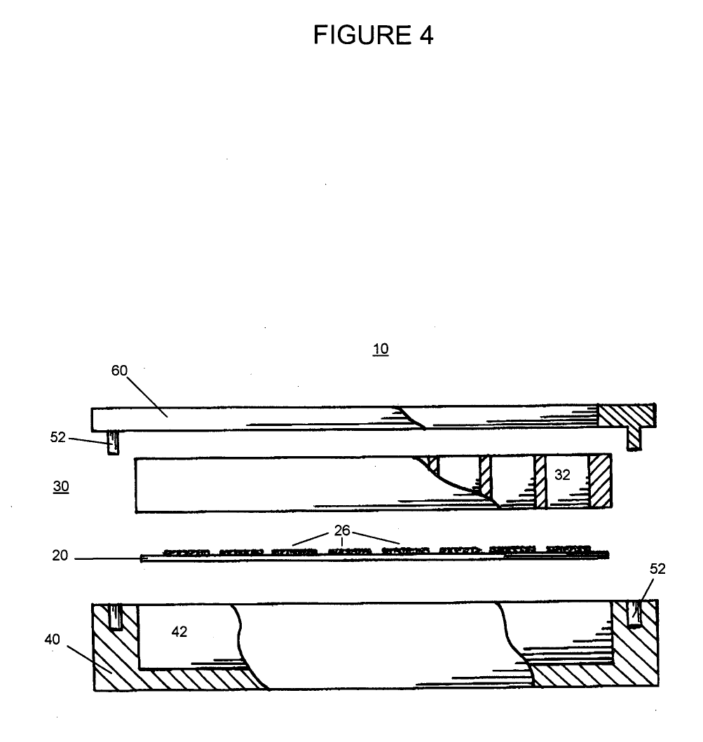

A second preferred embodiment of the present invention uses a lid to secure the chamber plate and microscope slide to the slide holder. As seen in FIGS. 3 and 4, at least one assay slide (20) as in the first preferred embodiment is associated with at least one corresponding multiwell chamber plate (30). The pair is placed in an opening (42) of a slide holder (40), also as described in the first preferred embodiment, with the slide holder comprising an upper surface, a lower surface, and a plurality of slide openings, each slide opening being dimensioned and configured so as to receive an assay slide from the upper surface. In this embodiment, however, the slide retention means comprises a top (60) that can be attached to the upper surface of the slide holder, such that each slide and corresponding chamber plate received in the corresponding slide opening in the slide holder is retained within the opening. The top has a series of openings (62) that register with the chamber wells, thereby allowing access to the wells with the top in place securing the chamber well plates. The top retains the plurality of chamber plates in a spaced array that registers with the retained slides and the corresponding assay reaction surface locations.

The second preferred embodiment can include many of the optional features of the first preferred embodiment, including a releaseable sealing means located on the bottom planar surface of the chamber plate such that each slide can be releaseably engaged with the chamber plate, each opening in the slide holder has one wall that slopes inward from an exterior wall of the slide holder such that the upper portion of the opening has an area less than that of the slide, thereby requiring the microarray slide to be tilted in order to be received within the opening, each assay slide has the same dimensions along the exterior edges and the planar surface, each slide has the same set of assay reaction surface locations.

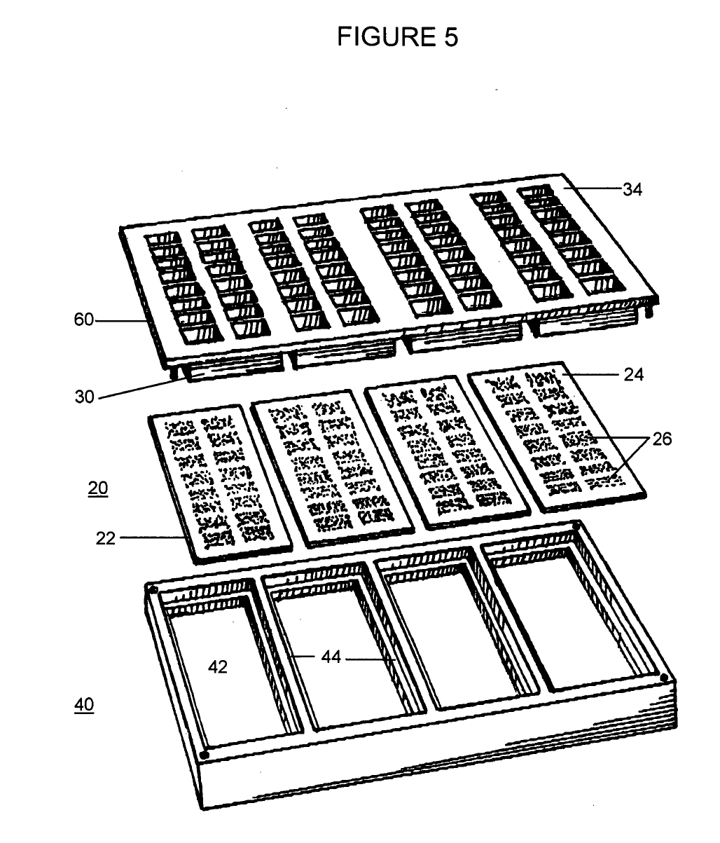

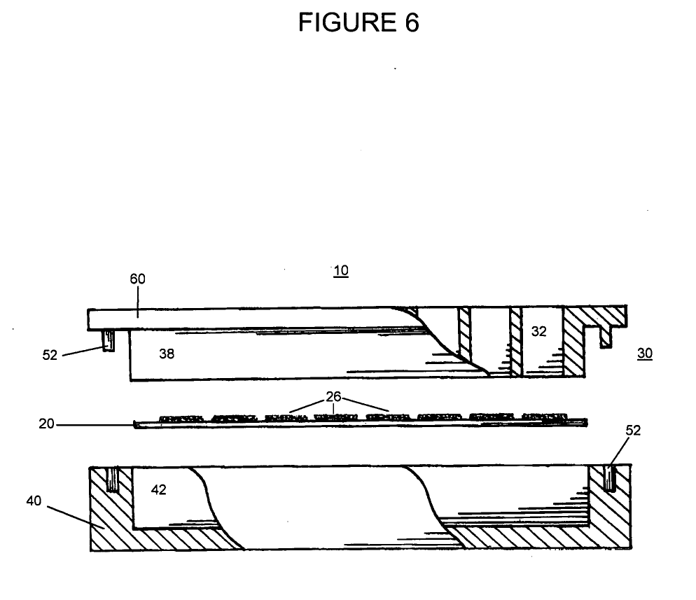

A third preferred embodiment is shown in FIGS. 5 and 6. It is a variation of the second preferred embodiment in that the top comprises the plurality of chamber plates in a spaced array that registers with the retained slides and the corresponding assay reaction surface locations.

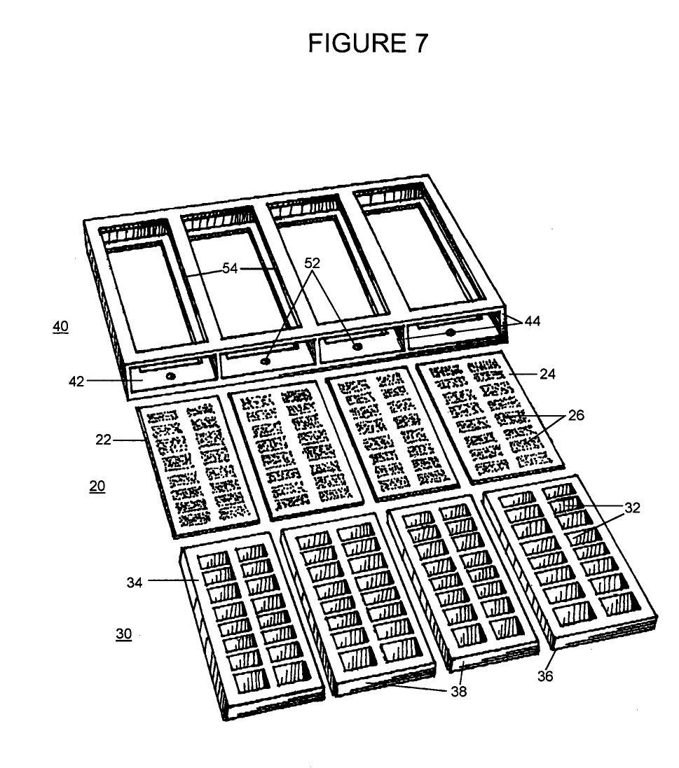

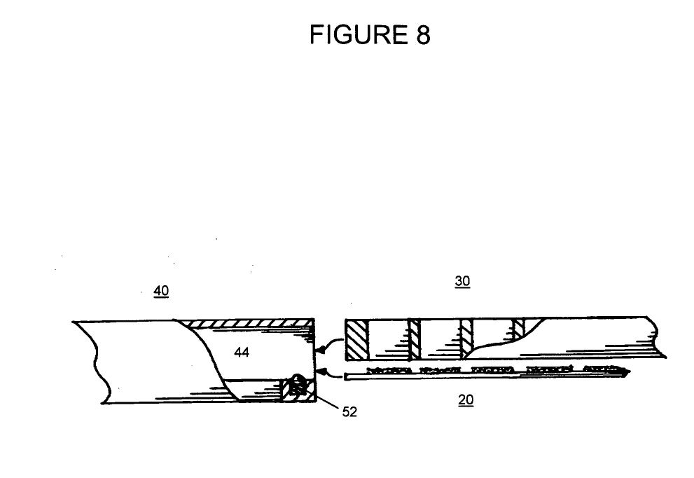

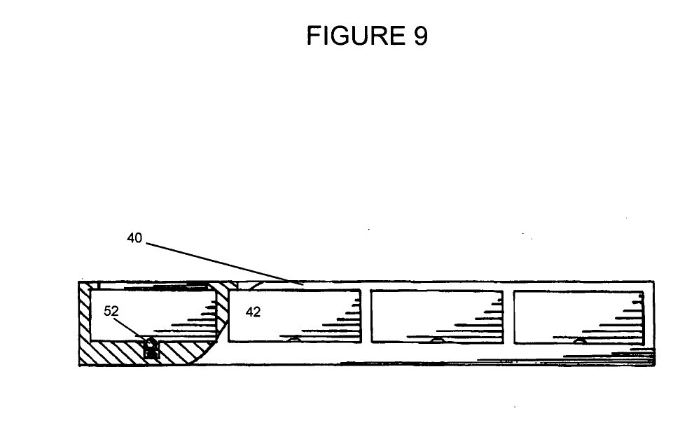

A fourth preferred embodiment is shown in FIGS. 7 to 9. Like the first preferred embodiment, the slide retention means is located in the slide holder. However, unlike the first preferred embodiment, the slide retention means (spring-loaded depressable ball 52) is located in a vertical operating position. Moreover, the slide holder has a slide opening (42) in the vertical exterior wall. Along with the shoulders (44) about the slide opening, flanges (54) are located along the upper surface so as to keep each slide from being removed by a horizontal movement. This structure permits a slide to be positioned in the slide holder with a horizontal movement that stops when one end of the slide engages the distal end of the slide opening, the spring loaded ball then being free of the slide at the proximal end of the slide opening.

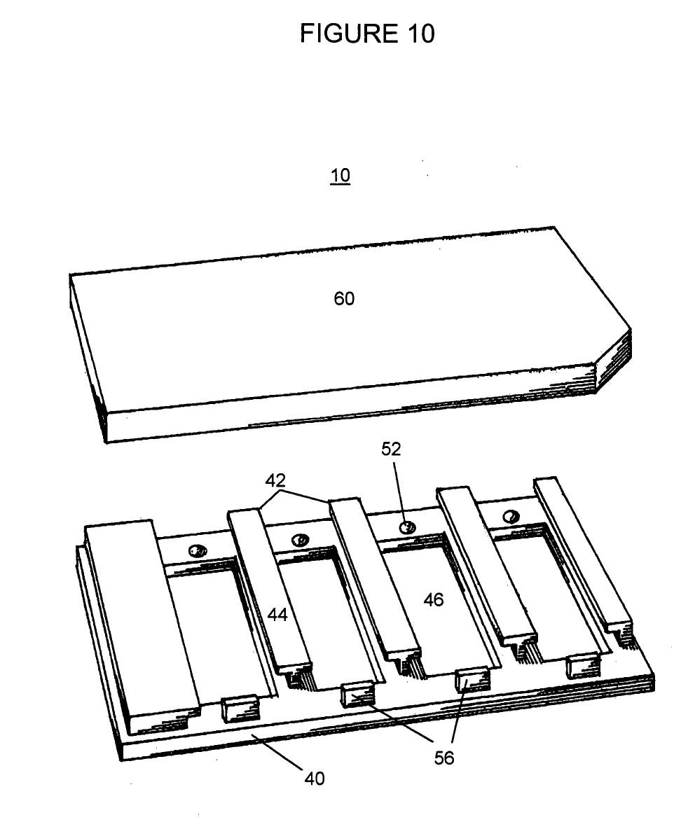

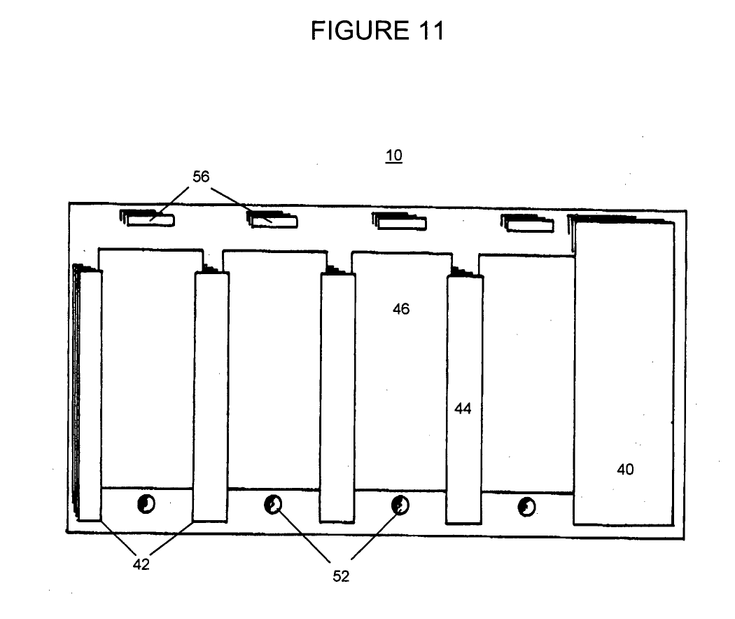

A fifth preferred embodiment is shown in FIGS. 10 and 11. Like the fourth preferred embodiment, the slide is placed in the slide holder through a horizontal movement. However, unlike the fourth preferred embodiment, the flanges (54) are not connected all about the upper surface of the slide holder. Instead a T-rail is used that provides lateral restraint for locating each slide in the vertical wall of the T-rail, as well as horizontal restraint for the chamber plate (30) and slide (20). Moreover, the end stops (56) are no longer connected as a single wall, being individual posts. Preferably, the slide holder can have an opening (46) in each slide receiving area. If the slide bottom is made of an appropriate material, such as glass, then a light energy signal can be read from underneath while the slide is in the slide holder. A conventional microwell top having a single clipped corner (60) can be used with the slide holder (40) if the end stop nearest that corner is appropriately located. This structure permits a slide to be positioned in the slide holder with a horizontal movement that stops when one end of the slide engages the distal end of the slide opening, the spring loaded ball then being free of the slide at the proximal end of the slide opening.

In all of these embodiments, the microarray sample device can have a plurality of assay reaction sites at each assay reaction surface location. The reaction sites can be grouped so as to form a microarray at each assay surface reaction location.

In all of these embodiments, the microarray sample device can have at least two assay surface locations have the substantially identical pattern of assay reaction sites.

### EXAMPLE OF DEVICE USE

Sixteen pad FAST brand slides (made by Schleicher and Schuell BioScience, Inc. of Keene, N.H., USA) were arrayed with commercially available anti-IL6 antibody at concentrations of 1 mg/ml, 0.5 mg/ml, 0.25 mg/ml and buffer only using a Perker Elmer BioChip Arrayer (made by Perkin Elmer of Boston, Mass. The arrayed slides were placed in a slide holder as shown in FIG. 1 and processed using a Perkin Elmer MultiProbe II HT liquid handler (made by Perkin Elmer of Boston, Mass.

The slides were blocked for 15 minutes in 70 ul/well of a blocking buffer (1× Tris buffered saline (TBS), 2% Tween20 surfactant, 0.1% polyvinyl pyrriladone, and 0.5% polyvinyl alcohol). The blocking buffer was removed using the liquid handler. A solution of 1 mg/ml IL6 antigen in RPMI with 10% fetal calf serum was added to the well at 70 ul/well. The slides were incubated with antigen for 1 hour while rotating the slide holder.

After a first incubation, the antigen solution was removed and the slides were washed 3 times with 70 ul wash buffer (1× TBS and 0.1% Tween20 surfactant) by dispensing the buffer, pipetting up and down 3× and removing buffer with the liquid handler. The slides were incubated with 70 ul of biotinylated anti-IL6 antibody at a concentration of 100 ng/ml for 1 hour while rotating the slide holder.

After a second incubation, the slides were washed again as described above. A solution of streptavidin-Cy5 (a 1:8000 dilution of a 1 mg/ml stock) was added to the wells at 70 ul/well. The slides were incubated at 1 hour while rotating the slide holder. The slides were then washed again as described above, dried at 80 C for approximately 1 minute and scanned using a GSI Lumonics ScanArray 4000 scanner at laser PMT settings of 85:50 (made by Perkin Elmer of Boston, Mass.). All of the slides could be read as if processed individually.

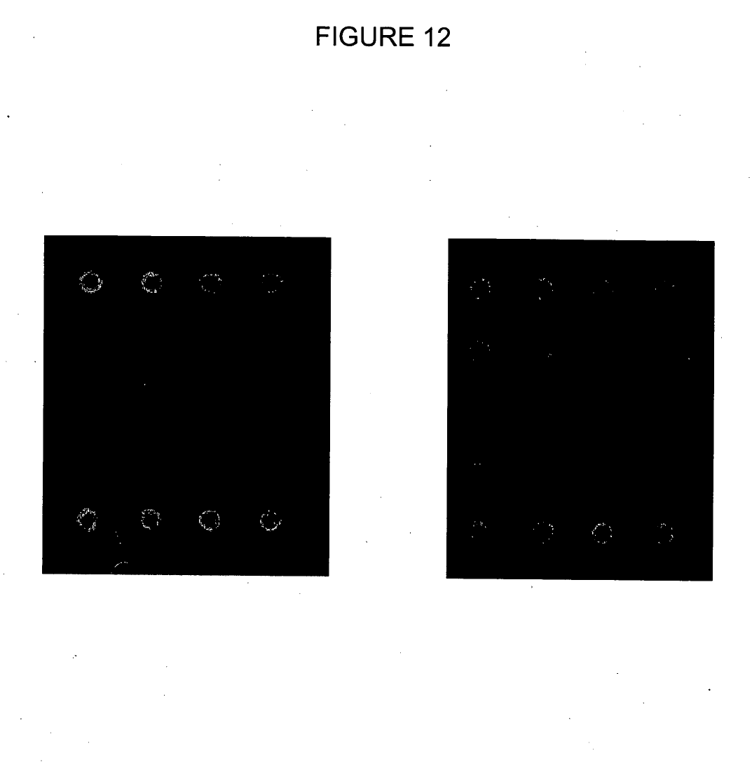

As shown in FIG. 12, the results demonstrate that the present device allows for the simultaneous processing of multiple samples on multiple arrays. One can see digital images of arrays of six anti-human cytokine antibodies on 16-pad FAST Slides loaded in the present invention and processed using an automated liquid handling system (PerkinElmer MultiPROBE® II). The antibodies have been used to interrogate treated or untreated cell lysates. Briefly, THP-1 cells were incubated with or without lipopolysaccharide (LPS). Cells have been lysed. The crude lysates have been diluted 1:10 with media, and incubated with four previously arrayed 16-pad FAST Slides. After incubation, the arrays have been developed with biotinylated antibody cocktail and streptavidin-Cy™ 5 dye markers. Arrays are imaged in a PerkinElmer ScanArray® 4000 device.

The left hand image shows IL-1b expression is increased in LPS-treated cells, while the right hand image shows IL-8 expression also is increased in LPS-treated cells. All transfer steps are performed using automated liquid handling.

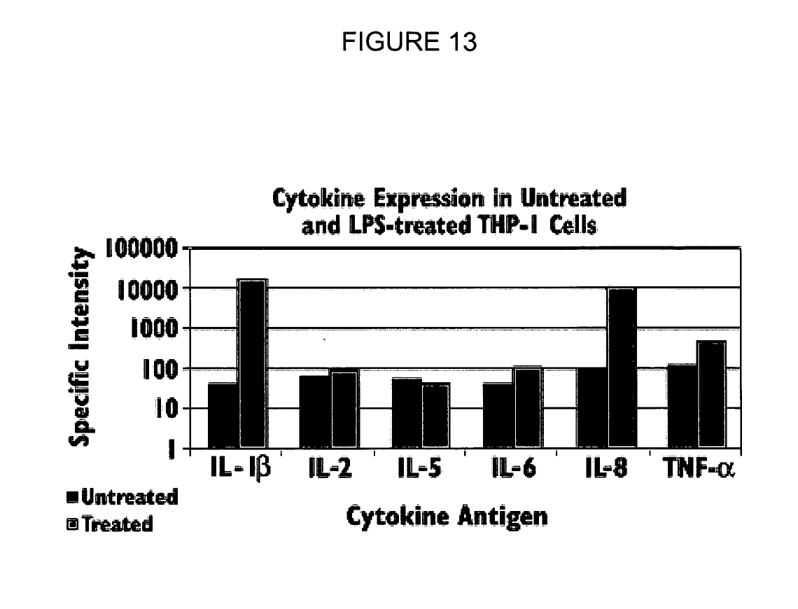

The images in FIG. 12 have been quantified using PerkinElmer QuantArray™ software. The specific intensities from duplicates of six cytokine antigens are averaged and plotted to compare expression levels in untreated and LPS-treated cells. As shown in FIG. 13, the data from the untreated lysate show endogenous cytokine expression in THP-1 cells, and the treated array shows increases in IL-1b and IL-8 levels after stimulation with LPS

The ordinarily skilled artisan can appreciate that the present invention can incorporate any number of the preferred features described above.

All publications or unpublished patent applications mentioned herein are hereby incorporated by reference thereto.

Other embodiments of the present invention are not presented here which are obvious to those of ordinary skill in the art, now or during the term of any patent issuing from this patent specification, and thus, are within the spirit and scope of the present invention.

1. A device for preparing multiple assay samples comprising:
a) at least one assay slide, each slide comprising a planar support having a set of exterior edges and a planar surface covered with a plurality of separate and discretely spaced assay reaction surface locations that are each treated so as to provide a reaction surface for a sample that is to be assayed for a genomic or proteomic activity, the assay reaction surface locations being present at a density of at least eight per eighteen square centimeters;
b) at least one planar multiwell chamber plates, each chamber plate comprising a plurality of bottomless wells located between a top planar surface and a bottom planar surface and encompassed by a set of exterior wall surfaces, each chamber plate being dimensioned and configured so as to register the wells with the assay reaction surface locations of a corresponding assay slide, each chamber plate being located adjacent to and in registration with the corresponding assay slide, wherein each well is dimensioned to encompass the area of a corresponding assay reaction surface location on an assay slide, each well is discrete from the other and is dimensioned so as to receive a sample, and each well has an opening that can communicate with the corresponding assay reaction surface location;
a) a slide holder comprising at least one slide openings, each slide opening being dimensioned and configured so as to receive an assay slide; and
b) a slide retention means being attached to the slide holder such that each slide and corresponding chamber plate received in the corresponding opening in the slide holder is retained within the opening.

2. The multiple assay sample device of claim 1 also comprising a releaseable sealing means located on the bottom planar surface of the chamber plate such that each slide can be releaseably engaged with the chamber plate.

3. The multiple assay sample device of claim 1 wherein each slide opening in the slide holder has one wall that slopes inward from an exterior wall of the slide holder such that the upper portion of the opening has an area less than that of the slide, thereby requiring the slide to be tilted in order to be received within the opening.

4. The multiple assay sample device of claim 1 wherein each assay slide has the same dimensions along the exterior edges and the planar surface.

5. The multiple assay sample device of claim 1 wherein each assay slide has the same number and spacing of assay reaction surface locations.

6. The multiple assay sample device of claim 1 wherein the assay reaction surface locations on each slide are spaced apart about nine millimeters on center, the slide holder has exterior dimensions that correspond to a SBS standard microplate, and each slide opening receives the corresponding slide such that the assay reaction surface locations are registered with the well format that corresponds to the SBS standard microplate.

7. The multiple assay sample device of claim 6 wherein the SBS standard microplate has 24 wells, 64 wells, 96 wells, or 384 wells.

8. The multiple assay sample device of claim 1 wherein each assay reaction surface location has a plurality of assay reaction sites.

9. The multiple assay sample device of claim 8 wherein at least two assay reaction surface locations have the substantially identical pattern of assay reaction sites.

10. The multiple assay ssample device of claim 1 wherein the slide opening is in a vertical surface of the slide holder thereby allowing the slide to be received by a horizontal movement of the slide.

11. The multiple assay sample device of claim 1 wherein the slide opening is in a horizontal surface of the slide holder thereby allowing the slide to be received by a vertical movement of the slide.

12. A device for preparing multiple assay samples comprising:
a) at least one assay slide, each slide comprising a planar support having a set of exterior edges and a planar surface covered with a plurality of separate and discretely spaced assay reaction surface locations that are treated so as to provide a reaction surface for a sample that is to be assayed for a genomic or proteomic activity, the assay reaction surface locations being present at a density of at least eight per eighteen square centimeters;
b) at least one planar multiwell chamber plate, each chamber plate comprising a plurality of bottomless wells located between a top planar surface and a bottom planar surface and encompassed by a set of exterior wall surfaces, each chamber plate being dimensioned and configured so as to register the wells with the assay location surfaces of a corresponding assay slide, each chamber plate being located adjacent to and in registration with the corresponding assay slide, wherein each well is dimensioned to encompass the area of a corresponding assay reaction surface locations on the corresponding assay slide, each well is discrete from the other and is dimensioned so as to receive a sample, and each well has an opening that can communicate with the corresponding assay reaction surface location;
c) a slide holder comprising an upper surface, a lower surface, and a plurality of slide openings, each slide opening being dimensioned and configured so as to receive an assay slide from the upper surface; and
d) a slide retention means comprising a top that can be attached to the upper surface of the slide holder such that each slide and corresponding chamber plate received in the corresponding slide opening in the slide holder is retained within the opening.

13. The multiple assay sample device of claim 12 also comprising a releaseable sealing means located on the bottom planar surface of the chamber plate such that each slide can be releaseably engaged with the chamber plate.

14. The multiple assay sample device of claim 12 wherein each opening in the slide holder has one wall that slopes inward from an exterior wall of the slide holder such that the upper portion of the opening has an area less than that of the slide, thereby requiring the slide to be tilted in order to be received within the opening.

15. The multiple assay sample device of claim 12 wherein each slide has the same dimensions along the exterior edges and the planar surface.

16. The multiple assay sample device of claim 12 wherein each slide has the same number and spacing of assay reaction surface locations.

17. The multiple assay sample device of claim 12 wherein the assay reaction surface locations on each slide are spaced apart about nine millimeters on center, the slide holder has exterior dimensions that correspond to a SBS standard microplate, and each slide opening receives the corresponding slide such that the assay reaction surface locations are registered with the well format that corresponds to the SBS standard microplate.

18. The multiple assay sample device of claim 17 wherein the SBS standard microplate has 24 wells, 64 wells, 96 wells, or 384 wells.

19. The multiple assay device of claim 12 wherein the top also comprises the plurality of chamber plates, the plates being located about the top in a spaced array that registers with the retained slides and the corresponding assay reaction surface locations.

20. The multiple assay device of claim 12 wherein the top retains the plurality of chamber plates in a spaced array that registers with the retained slides and the corresponding assay reaction surface locations.

21. The multiple assay sample device of claim 12 wherein each assay reaction surface location has a plurality of assay reaction sites.

22. The multiple assay sample device of claim 21 wherein at least two assay surface locations have the substantially identical pattern of assay reaction sites.

23. The multiple assay sample device of claim 12 wherein the slide opening is in a vertical surface of the slide holder thereby allowing the slide to be received by a horizontal movement of the slide.

24. The multiple assay sample device of claim 12 wherein the slide opening is in a horizontal surface of the slide holder thereby allowing the slide to be received by a vertical movement of the slide.

25. A method for processing multiple assay samples comprising adding a sample to at least one well in at least one chamber plate and corresponding slide in the device of claim 1, reacting the sample with the assay reaction surface location in the well, and measuring the signal from the reacted sample.

26. The method of claim 25 wherein the assay reaction surface location is prepared with the slide in the slide holder.

27. The method of claim 25 wherein the assay reaction surface location is prepared before the slide is located in the slide holder.

28. The method of claim 25 wherein the signal is measured with the slide removed from the slide holder.

29. The method of claim 25 wherein the sample is applied by a robotic sample application means.

30. The method of claim 25 wherein the signal is measured by a robotic signal measurement means.

31. The method of claim 25 wherein the sample is selected from the group consisting of cell lysates, cell supernatants, plasma, serum, or biological fluids.

32. The method of claim 25 wherein a plurality of samples are applied, each to a respective assay reaction surface location, each assay reaction surface location having a substantially identical set of assay reaction sites.

33. The method of claim 32 wherein the signal from the samples are compared so as to identify redundant reaction patterns that indicate any similarities within the samples.
